(19) United States
(12) Patent Application Publication
(10) Pub. No.: US 2004/0012499 A1
(43) Pub. Date: Jan. 22, 2004

(54) Occupant-presence sensing

(76) Inventors: Ruediger Giesel, Stuttgart (DE); Rene Wolf, Schwieberdingen (DE); Thomas Lich, Schwaikheim (DE); Frank Mack, Stuttgart (DE)

Correspondence Address: KENYON & KENYON, ONE BROADWAY, NEW YORK, NY, 10004, US

(21) Appl. No.: 10/410,632

(22) Filed: Apr. 9, 2003

(30) Foreign Application Priority Data
Apr. 9, 2002 (DE) 102 15 390.6

(51) Int. Cl. G08B 21/00

(52) U.S. Cl. 340/665; 340/425.5; 340/667

(57) ABSTRACT

To sense the occupancy status of the seat surface of a seat, in particular in a vehicle, an electrically conductive foamed plastic is used, at least in sections, in the seat surface, and a signal corresponding to the resistance value between a top-side and a bottom-side electrode is utilized for discrimination purposes to determine whether the seat is occupied or not. An array of a plurality of parallel strips or a matrix of patches of the conductive foamed plastic permits a more thorough discrimination in terms of the occupying object or the occupying person.

### FIELD OF THE INVENTION

The present invention is directed to a system for sensing the occupancy of a seat, in particular in a vehicle, which has a seat surface manufactured from foamed plastic, in this system, given occupancy of the seat, an electric signal being able to be tapped off, which is able to be distinguished from an electric signal given an unoccupied seat.

### BACKGROUND INFORMATION

To avoid an unnecessary triggering of restraint systems in motor vehicles, such as front airbags, side airbags, seat-belt tensioners, and the like, it is necessary to ascertain whether a seat to which such restraint systems are assigned, is also occupied. Moreover, it is also expedient to be able to determine whether a small or a large person is seated on the seat, or whether a definable object, such as a child safety seat or an infant carrier, is located there, because in certain situations, the triggering of a specific restraint system or a specific type of triggering could be dangerous. For example, it is beneficial to be able to adapt the triggering of a restraint system to the small or large stature of a vehicle occupant.

A typical system is known from the European Published Patent Application No. 100 26 90. In the occupied state of a seat, a conductive part built into its seat area changes its distance to a circuit arrangement having a transmitting/receiving antenna built into the seat An oscillator emits a weak high-frequency wave via the antenna, and the distance between the conductive part and the antenna that characterizes an occupancy state, influences the voltage that is able to be detected by the same antenna. The voltage can be detected and evaluated in terms of its level to determine whether the seat is occupied or not. The known system is quite complicated and requires permanently installing the conductive part in the seat area.

It has also been proposed to provide capacitance electrodes in the seat backrest and in the seat area and to evaluate a change in capacitance by measuring a change in the electric field. Furthermore, it has been proposed to provide a plurality of pressure sensors in the seat area and/or in the seat backrest (Japanese Published Application No.2669656).

Finally, optical systems reminiscent of measurement systems have also been proposed which utilize infrared lasers, these systems also being able to recognize the head position of an occupant. All of these systems are likewise extremely complicated and, thus, also costly and susceptible to failure.

### SUMMARY OF THE INVENTION

In contrast, it is an object of the present invention to provide a system for detecting seat occupancy which is simple in design, and in which received electric signals are able to be discriminated by using a simple circuit arrangement.

This objective is achieved in accordance with the present invention in that, as foamed plastic, an electrically conductive material is used, which has one electrode on each of the top and bottom sides, between which the electric signal to be discriminated is able to be tapped off. In this context, the present invention starts out from the realization that conductive foamed plastics were recently developed and that, in motor vehicles in particular, the seat surfaces of the seats are made, for the most part, of foamed plastic.

Thus, in the simplest case, instead of fabricating the seat from traditional foamed plastic, it suffices to manufacture it out of conductive foamed plastic and to detect an electric signal between the two electrodes which corresponds to the resistance value of the conductive foamed plastic between the electrodes in response to an unoccupied or occupied seat. Through multi-step evaluation, thus by comparing the detected signal with various threshold-value signals, the weight of the person or of the object occupying the seat may also be evaluated.

It may be expedient to fabricate only one section of the seat from conductive foamed plastic, namely that section which is occupied.

By arranging strips of conductive foamed plastic in a seat surface, and, in fact, in the context of a vehicle, in parallel to the driving direction, in a separate evaluation, the detected electric signals may be assessed and evaluated from strip to strip to determine whether an object or a person is occupying the seat and, in the latter case, to determine the person's ischial tuberosity, from which inferences may be made, in turn, regarding the type of person (petit, and, thus, more likely of small stature, or stout, and, therefore, more likely of large stature).

A further advantage is attained by a matrix configuration of patches of electrically conductive foamed plastic in the seat surface, since then, when the electric signals are evaluated from patch to patch, one is able to acquire discriminable impression profiles, for instance of objects, such as child safety seats or infant carriers.

The system according to the present invention may also be used in the seat backrest and/or in the headrest of the seat.

### BRIEF DESCRIPTION OF THE DRAWINGS

FIG. 1 shows schematically, in a part-sectional side view, a seat provided with a system according to the present invention, in a vehicle.

FIG. 2 is a first schematic illustration of the principle of operation of the system according to the present invention.

FIG. 3 is a second schematic illustration of the principle of operation of the system according to the present invention.

FIG. 4 shows a view of a further refinement of the present invention including strips of conductive foam material arranged in parallel.

FIG. 5 shows a view of a further refinement of the present invention including patches of conductive foam material arranged in a matrix configuration.

### DETAILED DESCRIPTION

A seat 1 in a schematically indicated vehicle 2 has a seat surface 3, a seat backrest 4 and a headrest 5. Armrests may also be provided (not shown). Seat surface 3 is fabricated, for the most part, from a foamed plastic, seat surface 3 having a specific contour (not shown). In addition, foamed plastic 6 is provided with a cover of textile material or leather. Moreover, foamed plastic 6 of seat surface 3 may have, as is customary per se, supporting and bearing devices, as well as connection devices 7 connecting to chassis 2, or rather to a rail 8 connected to chassis 2.

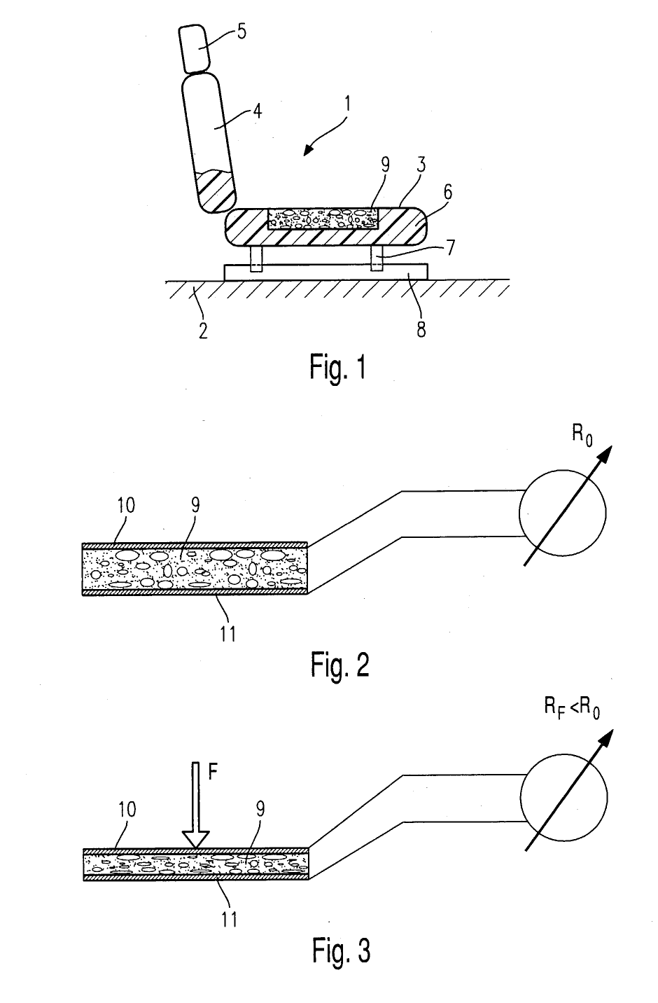

In accordance with the present invention, in the exemplary embodiment according to FIG. 1, seat surface 3 is, in fact, predominately manufactured from electrically non-conductive, conventional foamed plastic, but has, however, over a substantial section an electrically conductive foamed plastic 9, this section substantially corresponding to the surface area that a person takes up when sitting on seat surface 3 of seat 1.

Of course, seat surface 3 of seat 1 may be completely made of electrically conductive foamed plastic 9, which is not shown in detail.

Electrically conductive foamed plastic 9 is provided on the top and bottom sides with electrodes 10 and 11, respectively, which is not shown in detail in FIG. 1, but is explained in greater detail, however, on the basis of FIGS. 2 and 3.

Between electrodes 10 and 11, which cover electrically conductive foamed plastic 9 on the top and bottom sides, an electric signal corresponding to the resistance between electrodes 10 and 11 may be tapped off. In the unloaded state, which corresponds to the situation where seat 1 is not occupied, a resistance value R₀ is recorded. If, in response to occupancy of the seat, electrically conductive foamed plastic 9 is compressed, a force F (FIG. 3) thus being exerted on the foamed plastic, then the resistance value changes. As a result of compression of the pores or cells of electrically conductive foamed plastic 9, the contact surface increases and, consequently, electrical resistance R_{F} decreases as compared to resistance value R₀, given non-occupied seat 1.

Resistance value R_{F} is thus dependent on the weight of the occupying person or of the occupying object and, consequently, may also be classified within the discrimination limits by comparing it with various threshold values in the usual manner. Thus, it is possible to sense whether seat 1 is occupied and also whether the occupancy is by a person or an object of a light or heavy weight. On this basis, it is already possible to prevent a specific restraint system from being triggered, for instance given an unoccupied seat, or to activate the restraint system in a different manner in dependence upon the weight detected.

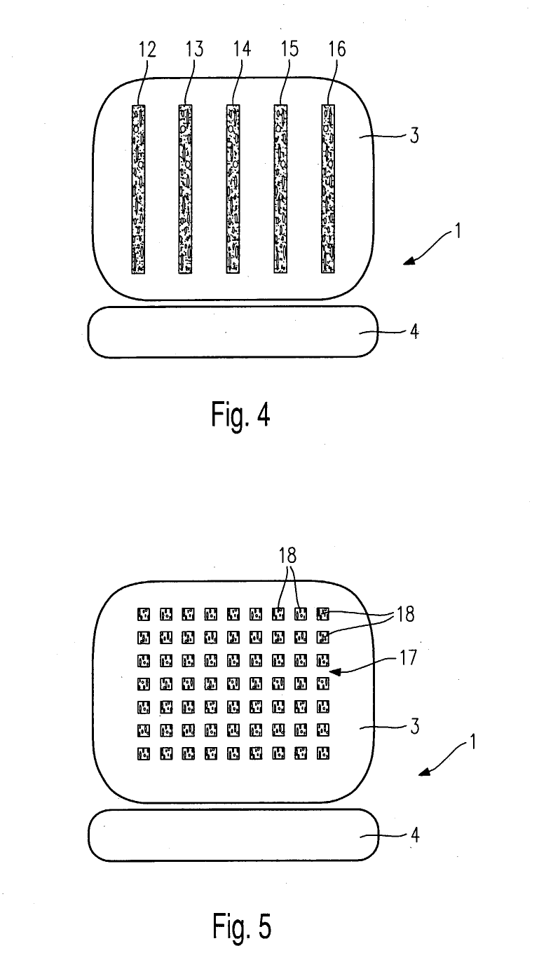

FIG. 4 shows another refinement where, instead of a complete section having a surface, a plurality of strips 12 through 16 of conductive foamed plastic, together with the corresponding electrodes, are built into seat surface 3 of seat 1. Strips 12 through 16 are essentially arranged in parallel and, in fact, in parallel with the driving direction of the vehicle in which seat 1 is situated. Resistance values R_{F12} through R_{F16} recorded for individual strips 12 through 16 make it possible for conclusions to be drawn as to whether seat 1 is occupied by an object or by a person having a small or large ischial tuberosity.

FIG. 5 schematically depicts a system where the electrically conductive foamed plastic 9, in the form of patches 18 arranged in a matrix 17, is installed with the particular electrodes in seat surface 3 of seat 1. Thus, compared to the system according to FIG. 4, an even more precise distribution of various contact points of the object occupying seat surface 3, or of the person, occupying seat surface 3, may be sensed, so that inferences may be made, for example in the case of objects, as to whether it is a question of a well defined object, such as a child safety seat or an infant carrier.

Of course, the system according to the present invention is also applicable to seat backrest 4 and/or to headrest 5, so that, overall, therefore, in evaluating the contour of a seated person, conclusions may be drawn, in particular with respect to the position of this person's head.

A benefit of the system according to the present invention is that a later recycling operation is facilitated particularly when the non-conductive foamed plastic 6 and the conductive foamed plastic 9 are foamed plastics of the same type.

In addition, it is possible to place conductive foam material 9 in seat surface 3, or also in seat backrest and headrest 5, already at the time of manufacture, thereby reducing the manufacturing costs.

It should noted, moreover, that the system according to the present invention may also be used together with other subsequently installed, conventional systems for sensing occupancy, i.e., for detecting the presence of an object or person. In a given case, the metallic seat shell which accommodates seating surface 3 may be used as bottom electrode 11, and the transmitting antenna of a conventional OC/AKSE sensor mat as a top electrode.

The electric signals, which are able to be tapped off between electrodes 10, 11 of conductive foamed plastic 9 may be fed, in a generally known way, into an internal-vehicle network, which has become known by the designation CAN. In this way, they may be used in the further processing for the purpose of sensing the presence of occupants and for triggering control circuits.

### Reference Numeral List

| | |
|---|---|
| 1 | seat |
| 2 | vehicle |
| 3 | seat surface |
| 4 | seat backrest |
| 5 | headrest |
| 6 | foamed plastic |
| 7 | connecting device |
| 8 | rail |
| 9 | electrically conductive foamed plastic |
| 10 | electrodes |
| 11 | electrodes |
| 12-16 | strips |
| 17 | matrix |
| 18 | patches |

What is claimed is:

1. A system for sensing an occupancy of a seat, comprising:
a seat surface manufactured from a foamed plastic, wherein, given an occupancy of the seat, an electric signal is able to be tapped off, a first value of the electric signal given the occupancy of the seat being distinguishable from a second value of the electric signal present when the seat is unoccupied, wherein:
the foamed plastic includes an electrically conductive foamed plastic, the foamed plastic includes a first electrode on a top side and a second electrode on a bottom side, and
the electric signal is able to be tapped off between the first electrode and the second electrode.

2. The system as recited in claim 1, wherein:
the seat is located in a vehicle.

3. The system as recited in claim 1, wherein:
the electrically conductive foamed plastic is only provided in sections of the seat surface.

4. The system as recited in claim 1, wherein:
the electrically conductive foamed plastic is arranged in a plurality of parallel strips that are configured separately from each other.

5. The system as recited in claim 4, wherein:
the parallel strips are situated in parallel with a driving direction of a vehicle in which the seat is located.

6. The system as recited in claim 1, wherein:
the electrically conductive foamed plastic is placed in a plurality of patches configured separately from one another in a matrix.

7. The system as recited in claim 1, wherein:
the system is arranged in at least one of a seat backrest and a headrest.
